(19) United States
(12) Patent Application Publication
(10) Pub. No.: US 2021/0368813 A1
(43) Pub. Date: Dec. 2, 2021

(54) Method of Dehydration of Chilies with Hardwood Smoke and the Chipotle and Habanero Powder Spice Blend Derived Therefrom

(71) Applicant: William M. Devine, JR., Plainfield, NJ (US)

(72) Inventor: William M. Devine, JR., Plainfield, NJ (US)

(21) Appl. No.: 16/890,213

(22) Filed: Jun. 2, 2020

(51) Int. Cl. A23B 7/02; A23P 10/22; A23L 19/00; A23L 27/10; A23L 27/16; A23L 27/18; A23L 27/12; A23L 27/40; A23B 7/022

(52) U.S. Cl. CPC A23B 7/0205; A23P 10/22; A23L 19/01; A23L 27/105; A23L 27/16; A23V 2002/00; A23L 27/12; A23L 27/40; A23B 7/0215; A23B 7/022; A23L 27/18

(57) ABSTRACT

A method of dehydrating and flavoring chili peppers by exposing them to the smoke from smoldering hardwoods. The smoking process occurs in a smoking vessel where the smoking temperature is in the range of 170° F. to 230° F. The smoking is maintained for a time period ranging from 15 to 20 hours. The smoked and dehydrated chilies are removed from the smoker and ground into a powder. Also disclosed is a specific spice mix derived from the smoked chilies produced by the method of the present invention.

### FIELD OF THE INVENTION

The present invention is a method of dehydrating chilies with hardwood smoke and further claims the specific powder spice blend derived from said dried chilies.

### BACKGROUND OF THE INVENTION

People often process their food by exposing it to the smoke of various types of smoldering wood. Smoking of food has typically been utilized in connection with meat and fish. Specifically, various woods emit smoke when they are caused to smolder. When foods are exposed to the smoke of smoldering wood, the food slowly becomes dehydrated thereby preserving the food. Furthermore, by a selective choice of the appropriate wood, the food may be imparted with a distinctive flavor of the wood or combination of woods.

Smoking is typically done in a smoker. The smoker is a vessel that has a chamber for retaining the smoldering wood and may include a support member or a separate chamber to retain the foods to be smoked. Alternatively, the smoker may be all inclusive (food, smoke and fire) within a domed smoker unit using an indirect heat method. Thereupon, the wood is exposed to heat to cause it to smolder and exude flavorful smoke and the food is introduced into the smoker. The food remains in the smoker for a predetermined span of time and at a predetermined smoking temperature.

Chili peppers are a well-known food product which are utilized as a source of nutrition and as a flavoring added to other foods. Depending on the variety, chili peppers range from sweet, to mildly spicy, to quite spicy to extremely hot. The placenta and capsaicin glands within a chili generate the heat source of capsaicin. It is known in the prior art to dehydrate chili peppers so that the dehydrated chili peppers can be stored for long periods of time without spoiling. The chilies can then be added to recipes or other foods to add flavor and spice. Until now, chili peppers have been air-dried where they are hung to dry for extended periods of time in order to dehydrate them. Alternatively, the chilis can be placed in a warm oven to dry them.

It would be advantageous to smoke chili peppers in a smoker to dehydrate them and to cause them to be infused with the flavor of the smoking hardwood. One advantage of smoking chilies is that the process is accelerated in comparison with air drying. Moreover, in comparison with air drying or oven drying, a flavor characteristic of the smoking wood is added to the product. Furthermore, once the chilies are smoked, preserved and granulated, they are easier to apply to food by shaking versus chopping. Herein is introduced a novel and non-obvious method of smoking chilies to dehydrate them and to introduce hardwood smoke flavor. Further introduced herein is a specific spice blend formulated from the smoked chilies of the present method.

Other objects, advantages and novel features, and further scope of applicability of the present invention will be set forth in the detailed description to follow, taken in conjunction with the accompanying drawings, and in part will become apparent to those skilled in the art, upon examination of the following, or may be learned by practice of the invention. The objects and advantages of the invention may be realized and attained by means of instrumentalities and combinations particularly pointed out in the appended claim or claims.

### SUMMARY OF THE INVENTION

The present invention is a method of dehydrating and flavoring chili peppers by exposing them to the smoke from smoldering hardwoods and charcoal briquettes. The smoking process occurs in a smoker where the smoking temperature is in the range of 170° F. to 230° F. for best dehydration and flavor characteristics. Moreover, the smoking is maintained for a time period ranging from 15 to 20 hours. Thereupon, the smoked and dehydrated chilies are removed from the smoker and ground into a powder. Also disclosed is a specific spice mix derived from the smoked chilies produced by the method of the present invention.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a flow chart and showing the series of steps as disclosed by the method of the present invention.

### DETAILED DESCRIPTION OF THE INVENTION

The present invention is a method of dehydrating chili peppers using smoldering hardwood and charcoal briquettes. Also disclosed is a novel and non-obvious spice blend mixture that includes the smoked, dehydrated chili peppers derived from the dehydration method shown.

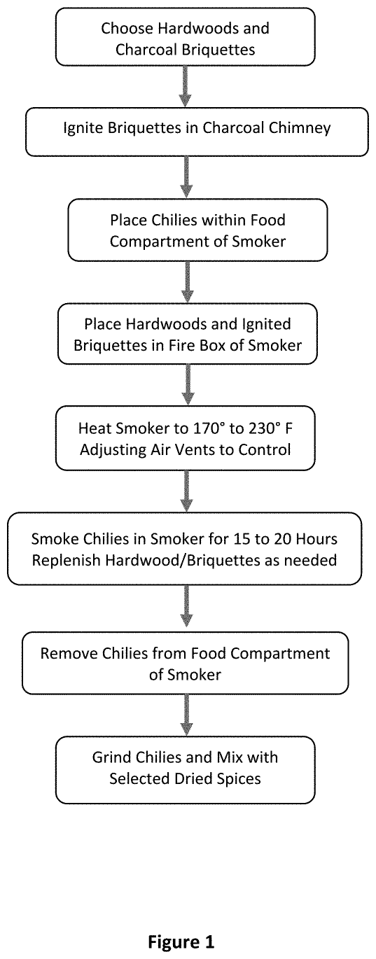

Referring to FIG. 1, the method of the present invention is disclosed. A smoking vessel is provided wherein the smoking vessel includes a chamber for introduction of hardwoods and/or charcoal briquettes also known as the fire box. The choice of particular hardwoods is dependent upon the particular smoky flavor to be imbued into the peppers. A typical selection of hardwood may include, but not be limited to, oak, cherry, hickory, pecan and/or maple, where each of these hardwoods or a combination thereof emits smoke with particular flavor characteristics when smoldering. Other hardwoods may be employed and will be within the scope of this disclosure. The hardwoods are heated to cause them to smolder and emit smoke. In the preferred method, the charcoal briquettes are ignited employing a charcoal chimney. The hot coals are then placed into the fire box of the smoker along with chunks and/or logs of the selected hardwood. For the desired flavor and dehydration effect, the range of temperature for the smoke upon the surface of the chili peppers should be between 170° and 230° F. It is found that by utilizing smoke in this range of temperatures, the method of the present invention is most advantageous.

Chili peppers are introduced into the food compartment of a smoker. The specific choice of chili pepper or peppers is determined by the user and not critical to the functionality of this method, but typically jalapenos, cayenne or habaneros may be employed. Other peppers are within the scope of this disclosure. The peppers may be in a separate chamber where they are exposed to the smoke from the smoldering hardwood. Instead, the smoker may include a shelf or other such support structure for supporting the chilies. The chilies are not placed in direct contact with the smoldering hardwood and briquettes, they are merely exposed to the smoke exuded from the hardwood, which smoke should be in the temperature range of between 170° and 230° F. It is found that this particular temperature range is high enough to slowly cause the dehydration of the chilies and cool enough that a great deal of flavor is imparted. The smoker uses air vents which may be selectively opened or closed, fully or partially, to increase or decrease the air flow within the smoker. By selectively opening and closing the air vents of the smoker, the user may control the interior temperature of the smoker, thereby maintaining the temperature in this desired range.

The length of time that the chilies are exposed to the hardwood smoke is also an important element of this disclosure. The chilies are exposed to the hardwood smoke for a period between 15 and 20 hours. This choice of time span is important because it will allow the chilies to be properly dehydrated and infused with hardwood smoke flavor. During the time period that the chilies are being exposed to the smoke, the hardwoods and briquettes are replenished in the fire box to maintain the proper temperature.

Once the chilies have been exposed to the smoke for the duration of time specified and at the smoke temperature specified, they are removed from the smoker. At this point, the chilies are properly dehydrated, and stored whole. (The chilies are stored whole to retain their flavor and potency.) When needed for spice blending, the dehydrated chilies are ground into a granular powder. The powdered chilies are properly dehydrated with all or most of the water removed and are imparted with a smoky flavor distinctive to the choice of hardwoods.

The dehydration of the chili peppers calcifies the capsaicin oils within the chili pepper placenta and ribs. (The capsaicin oils are the essential oils that give the chili its particular distinctive spicy hot flavor.) The act of dehydration by smoking is a key difference from prior-art chili preparations in that it drastically reduces the mouth numbing impact of acid burn. The smoke-dried chilies produce a slower time release of the capsaicin from the dehydrated chili placenta on the palate to quell the numbing impact. With low to no moisture, dehydrated chilies are more robust with flavor and pungency. Therefore, a smaller amount of chili powder with the calcified capsaicin oil reduces the numbing impact on the palate while providing concentrated flavor and spiciness.

Once the chilies have been removed from the smoker, whole smoke-dried chilies are packaged and stored until needed for processing. In a commercial kitchen, the smoke-dried chilies are ground. They are mixed with selected dried spices to create a bulk batch of a specific spice blend. In a commercial kitchen, the bulk batch of chili spice blend is placed into spice jars, labelled, and sealed for sale to consumers.

Also disclosed herein is a novel and non-obvious spice mixture that includes the smoked chilies of the present method. The specific mixture is 1½ tablespoon smoked chipotle chili, ¼ tablespoon smoked habanero chili, 1 tablespoon salt, ½ tablespoon garlic powder, ½ tablespoon onion powder, ½ tablespoon black pepper, ½ tablespoon white pepper, ½ tablespoon mustard powder. It will be understood that these measurements are exemplary. The spice mixture can be produced in any quantity with like proportions. As such, the spice mixture consists of 1½ part smoked chipotle chili, ¼ part smoked habanero chili, 1 part salt, ½ part garlic powder, ½ part onion powder, ½ part black pepper, ½ part white pepper, ½ part mustard powder.

The foregoing is considered as illustrative only of the principles and preferred embodiment of the invention. Furthermore, since numerous changes and modifications will readily occur to one skilled in the art, it is not desired to limit the invention to the exact construction, operation and embodiment shown and described, and accordingly all suitable modifications and equivalents may be resorted to, falling within the scope of the invention.

What is claimed:

1. A method of dehydrating and flavoring chili peppers comprising the steps of:
choosing hardwood and briquettes for their specific flavor characteristic;
igniting said briquettes;
placing chili peppers inside said vessel, thereby exposing said chili peppers to the smoke emitted from the hardwoods;
placing said ignited briquettes into a vessel along with said hardwoods;
causing said hardwood and briquettes to emit smoke, wherein said hardwoods and briquettes emit smoke at a temperature in the range of 170° F. to 230° F.;
exposing said chilis to the smoke emitted from the hardwoods for a period of time ranging from 15 to 20 hours;
removing the dehydrated and flavored chili peppers from said vessel; and
grinding said dehydrated chili peppers into a powder.

2. A spice mixture comprising:
1½ part smoked chipotle chili;
¼ part smoked habanero chili;
1 part salt;
½ part garlic powder;
½ part onion powder;
½ part black pepper;
½ part white pepper;
½ part mustard powder;
wherein said smoked chipotle chili and said smoked habanero chili are smoked by exposing them to the smoke of smoldering hardwood and briquettes for a time period in the range of 15 to 20 hours, which smoke is in the range of temperatures ranging from 170° F. to 230° F.
